(19) United States
(12) Patent Application Publication
(10) Pub. No.: US 2020/0029175 A1
(43) Pub. Date: Jan. 23, 2020

(54) INFORMATION PROCESSING SYSTEM

(71) Applicant: SHARP KABUSHIKI KAISHA, Sakai City, Osaka (JP)

(72) Inventors: ATSUSHI FUKUI, Sakai City, Osaka (JP); YUKI WATANABE, Sakai City, Osaka (JP); KEI KASAHARA, Sakai City, Osaka (JP); TOMOHISA YOSHIE, Sakai City, Osaka (JP); DAISUKE TOYOSHIMA, Sakai City, Osaka (JP)

(21) Appl. No.: 16/490,278

(22) PCT Filed: Mar. 2, 2018
(86) PCT No.: PCT/JP2018/007982

§ 371 Date: Aug. 30, 2019

(30) Foreign Application Priority Data
Mar. 29, 2017 (JP) 2017-065841

(51) Int. Cl. H04W 4/029

(52) U.S. Cl. CPC H04W 4/029; H04W 88/02

(57) ABSTRACT

An information processing system using a mobile terminal device includes: a plurality of transmission devices that are distributed over a predetermined region and that transmit mutually different identification information; a receiver, provided in the mobile terminal device, that receives the identification information; an information storage memory that stores device information including, for each of the plurality of transmission devices, the identification information and position information of the transmission device; an input device, provided in the mobile terminal device, that accepts an input of event information related to a subject; an acquisition circuitry that, based on the identification information received by the receive and the position information, acquires the position information of the mobile terminal device at the point in time when the input of the event information was accepted; and an output device that outputs event history information about the subject that includes the event information related to the subject and the position information of the mobile terminal device at the point in time.

### TECHNICAL FIELD

This international application claims priority based on Japanese Patent Application No. 2017-065841 filed Mar. 29, 2017, and the entirety of Japanese Patent Application No. 2017-065841 is incorporated herein by reference.

The present disclosure relates to an information processing system.

### BACKGROUND ART

In the past, a position measurement system that specifies the current position of a moving body indoors and the like has been used. In a position measurement system, radio transmitters are installed at multiple positions inside a facility, and in addition, a mobile terminal device is carried by a moving person. Radio waves from the radio transmitters are received by the mobile terminal device, and on the basis of the reception information of the mobile terminal device, it becomes possible for a server to confirm where the moving body is currently positioned.

For example, Japanese Unexamined Patent Application Publication No. 2015-200609 (PTL 1) discloses an in-area route guidance system. In this system, mutually different unique identification information is transmitted from multiple beacons inside an area. A portable terminal receives the unique identification information of a nearby beacon and refers to a server. The server sends beacon position information corresponding to the unique identification information about which the reference is made to the portable terminal, and the portable terminal acquires current position information. The portable terminal accepts target information of a user and acquires destination information based on attribute information about each place inside the area. Furthermore, the portable terminal searches for a recommended route from the current position to the destination on the basis of the current position information, the destination information, and route network information, and presents the recommended route.

### CITATION LIST

### Patent Literature

PTL 1: Japanese Unexamined Patent Application Publication No. 2015-200609

### SUMMARY OF INVENTION

### Technical Problem

However, although the system according to PTL 1 considers accurately acquiring position information about the current position and providing route guidance, a technical means for understanding what a subject has done specifically (behavior) at the position where the subject is located is not explained or suggested at all.

In one aspect, an objective of the present disclosure is to provide an information processing system enabling behavior of a subject to be understood appropriately.

### Solution to Problem

According to one embodiment, an information processing system using a mobile terminal device is provided. The information processing system includes: a plurality of transmission devices that are distributed over a predetermined region and that transmit mutually different identification information; a receiving means, provided in the mobile terminal device, that receives the identification information; an information storage means that stores device information including, for each of the plurality of transmission devices, the identification information and position information of the transmission device; an input means, provided in the mobile terminal device, that accepts an input of event information related to a subject; an acquisition means that, based on the identification information received by the receiving means and the position information, acquires the position information of the mobile terminal device at the point in time when the input of the event information was accepted by the input means; and an output means that outputs event history information about the subject that includes the event information related to the subject and the position information of the mobile terminal device at the point in time.

### Advantageous Effects of Invention

According to the present disclosure, it becomes possible to understand the behavior of a subject appropriately.

### BRIEF DESCRIPTION OF DRAWINGS

FIG. 1 is a diagram illustrating an overall configuration of an information processing system according to Embodiment 1.

FIG. 2 is a block diagram illustrating an example of a hardware configuration of the mobile terminal device according to Embodiment 1.

FIG. 3 is a block diagram illustrating a hardware configuration of a server according to Embodiment 1.

FIG. 4 is a diagram for explaining operations of the information processing system according to Embodiment 1.

FIG. 5 is a diagram illustrating device information of a transmitter according to Embodiment 1.

FIG. 6 is a diagram illustrating a determination table according to Embodiment 1.

FIG. 7 is a diagram illustrating event history information according to Embodiment 1.

FIG. 8 is a diagram illustrating an overall configuration of an information processing system according to Embodiment 2.

FIG. 9 is a diagram for explaining an example of operations of the information processing system according to Embodiment 2.

FIG. 10 is a diagram illustrating an overall configuration of an information processing system according to Embodiment 3.

FIG. 11 is a diagram for explaining an example of operations of the information processing system according to Embodiment 3.

FIG. 12 is a diagram illustrating an overall configuration of an information processing system according to Embodiment 4.

FIG. 13 is a diagram for explaining an example of operations of the information processing system according to Embodiment 4.

FIG. 14 is a diagram illustrating an overall configuration of an information processing system according to Embodiment 5.

FIG. 15 is a diagram illustrating an overall configuration of an information processing system according to Embodiment 6.

FIG. 16 is a diagram illustrating an example of operations of an information processing system according to Embodiment 6.

### DESCRIPTION OF EMBODIMENTS

Hereinafter, embodiments of the present disclosure will be described with reference to the drawings. In the following description, like components are denoted with like signs. The names and functions of such components are also the same. Consequently, a detailed description of such components will not be repeated.

### Embodiment 1

### <Overall Configuration of System>

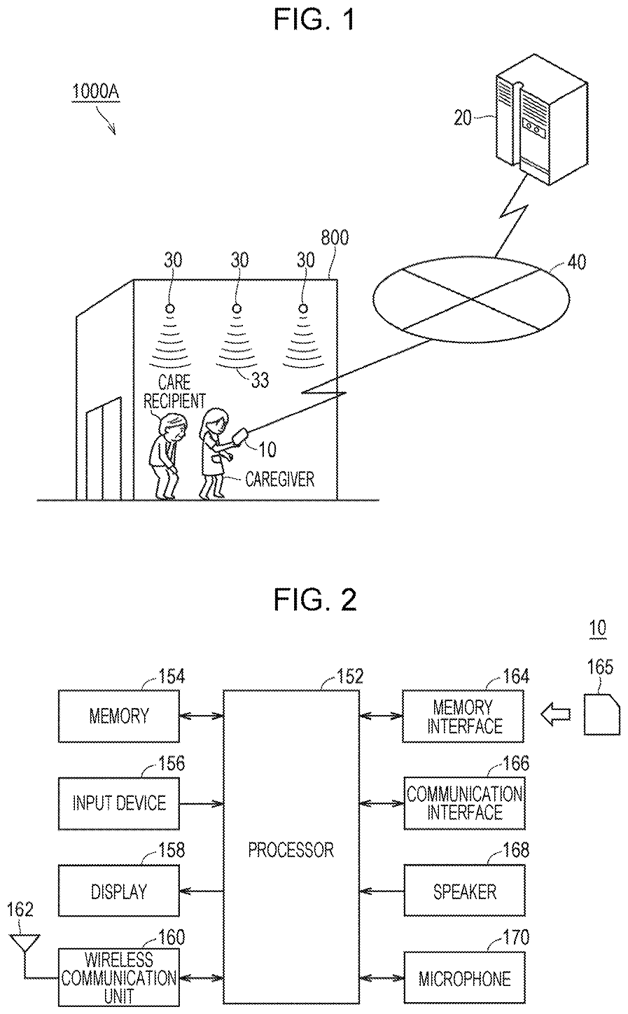

FIG. 1 is a diagram illustrating an overall configuration of an information processing system 1000A according to Embodiment 1. As illustrated in FIG. 1, the information processing system 1000A provides a service for reducing the burden of a caregiver who gives care to someone needing care (care recipient) inside a limited region 800. In the present embodiment, the “subject” whose behavior is managed will be described as the “care recipient”. The region 800 is a nursing home for the elderly, for example. Note that the region 800 is sufficiently a region in which the subject moves, and may also be a hospital, a commercial facility, an airport, a train station, an office building, or the like.

Referring to FIG. 1, the information processing system 1000A includes a mobile terminal device 10 of the caregiver, a server 20, multiple transmitters 30, and a network 40. In Embodiment 1, a situation is presumed in which the care recipient (for example, an elderly person) engages in behavior while being attended by the caregiver.

The mobile terminal device 10 and the server 20 are able to communicate over the network 40. The network 40 includes various types of networks such as the Internet and a mobile terminal communication network. The network 40 may adopt other wireless communication schemes such as wireless local area network (LAN).

The mobile terminal device 10 is a smartphone, for example. However, the mobile terminal device 10 may also be another mobile device such as a flip phone, a tablet, or a laptop personal computer (PC).

The multiple transmitters 30 are distributed inside the region 800. For example, the transmitters 30 are compact transmission modules (for example, transmitting beacon modules) with a built-in transmission circuit, and are equipped with a battery as a driving source. The transmitters 30 may also include a solar cell element as an independent power source. For example, the solar cell element is a dye-sensitized solar cell element.

The transmission circuit transmits a beacon signal 33 including identification information (a beacon ID) of the transmitter 30 to the area surrounding the transmitter 30 on a predetermined period (for example, 0.1 seconds). The mobile terminal device 10 receives the beacon signal 33. The communication standard used between the transmission circuit and the mobile terminal device 10 is a short-range wireless communication standard such as Bluetooth (registered trademark) or Bluetooth Low Energy (BLE), for example. For example, the transmitter 30 conforming to the BLE standard broadcasts advertising data including the beacon ID to the area surrounding the transmitter 30 as the beacon signal.

The locations where the transmitters 30 are disposed include various places such as a dining room, a bedroom, a rehabilitation room, a toilet, a bathroom, and the like inside the region 800. The transmitters 30 are installed on the ceiling, walls, floor, and the like of these locations. The arrangement spacing of the transmitters 30 is set appropriately according to the structure (such as the height of the ceiling and the width) of the region 800, the effective range of the beacon signal, and the like. Note that the effective range refers to the maximum distance between the transmitter 30 and the mobile terminal device 10 at which the mobile terminal device 10 is capable of receiving and processing the beacon signal 33.

The mobile terminal device 10 receives the beacon signal 33 from one or multiple transmitters 30 within the effective range from among the multiple transmitters 30 inside the region 800. The mobile terminal device 10 decodes the beacon ID from the received beacon signal 33, and computes the radio wave intensity of the beacon signal 33. With this arrangement, the mobile terminal device 10 receives the beacon signal 33 and acquires the beacon ID. The radio wave intensity is correlated with the distance between the mobile terminal device 10 and the transmitter 30, and increases in intensity as the distance becomes shorter. The mobile terminal device 10 executes the above process every time the beacon signal 33 is received.

The server 20, by exchanging various information with the mobile terminal device 10, cooperates with the mobile terminal device 10 and the like to execute the service provided by the information processing system 1000A. Detailed processes of the mobile terminal device 10 and the server 20 will be described later.

### <Hardware Configuration>

FIG. 2 is a block diagram illustrating an example of a hardware configuration of the mobile terminal device 10 according to Embodiment 1. Referring to FIG. 2, the mobile terminal device 10 includes a processor 152, memory 154, an input device 156, a display 158, a wireless communication unit 160, a communication antenna 162, a memory interface (I/F) 164, a communication interface (I/F) 166, a speaker 168, and a microphone 170 as principal component elements.

The processor 152 typically is a computational processing unit such as a central processing unit (CPU) or a multi-processing unit (MPU). The processor 152, by reading out and executing a program stored in the memory 154, functions as a controller that controls the operations of each unit of the mobile terminal device 10. By executing the program, the processor 152 achieves each of the processes (steps) of the mobile terminal device 10 described later.

The memory 154 is realized by random access memory (RAM), read-only memory (ROM), flash memory, and the like. The memory 154 stores programs executed by the processor 152, data used by the processor 152, and the like.

The input device 156 accepts operating input with respect to the mobile terminal device 10. Typically, the input device 156 is realized by a touch panel. The touch panel is provided on top of the display 158 that functions as a display unit, and is of the capacitive type, for example. The touch panel detects a touch operation on the touch panel performed by an external object at predetermined time intervals, and inputs touch coordinates into the processor 152. However, the input device 156 may also include buttons and the like.

The wireless communication unit 160 connects to the mobile communication network through the communication antenna 162, and transmits and receives signals for wireless communication. With this arrangement, the mobile terminal device 10 becomes able to communicate with other communication devices (for example, the server 20) over the network 40 (for example, a mobile communication network such as Long Term Evolution (LTE)).

The memory interface 164 reads out data from an external storage medium 165. The processor 152 reads out data stored in the storage medium 165 through the memory interface 164, and stores the data in the memory 154. The processor 152 reads out data from the memory 154, and stores the data in the storage medium 165 through the memory interface 164.

The storage medium 165 includes a medium that stores programs in a non-volatile manner, such as a Compact Disc (CD), a Digital Versatile Disc (DVD), a Blu-ray (registered trademark) Disc (BD), Universal Serial Bus (USB) memory, or a Secure Digital (SD) memory card.

The communication interface (I/F) 166 is a communication interface for exchanging various data between the mobile terminal device 10 and the transmitters 30, and is realized by an adapter, a connector, or the like. For the communication scheme, a wireless communication scheme according to Bluetooth (registered trademark) Low Energy (BLE), wireless LAN, or the like is adopted, for example.

The speaker 168 converts an audio signal supplied from the processor 152 into sound and outputs the sound externally to the mobile terminal device 10. The microphone 170 accepts speech input with respect to the mobile terminal device 10, and supplies a speech signal corresponding to the speech input to the processor 152. Note that the mobile terminal device 10 additionally includes an acceleration sensor and an angular velocity sensor, a timing unit for measuring time, and the like.

### (Server 20)

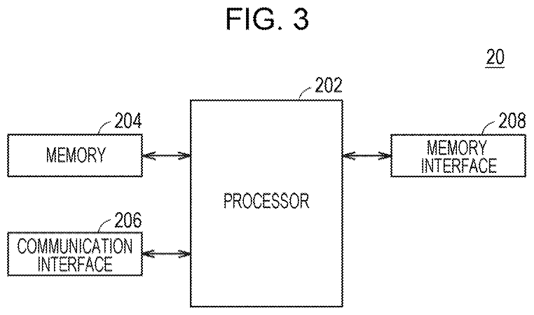

FIG. 3 is a block diagram illustrating a hardware configuration of the server 20 according to Embodiment 1. Referring to FIG. 3, the server 20 includes a processor 202 for executing various processes, memory 204 for storing programs, data, and the like executed by the processor 202, a communication interface (I/F) 206 for transmitting and receiving various data with each mobile terminal device 10, and a memory interface (I/F) 208 that reads out data from an external storage medium as principal component elements. Note that the server 20 additionally includes a timing unit for measuring time and the like.

### <Operations of System>

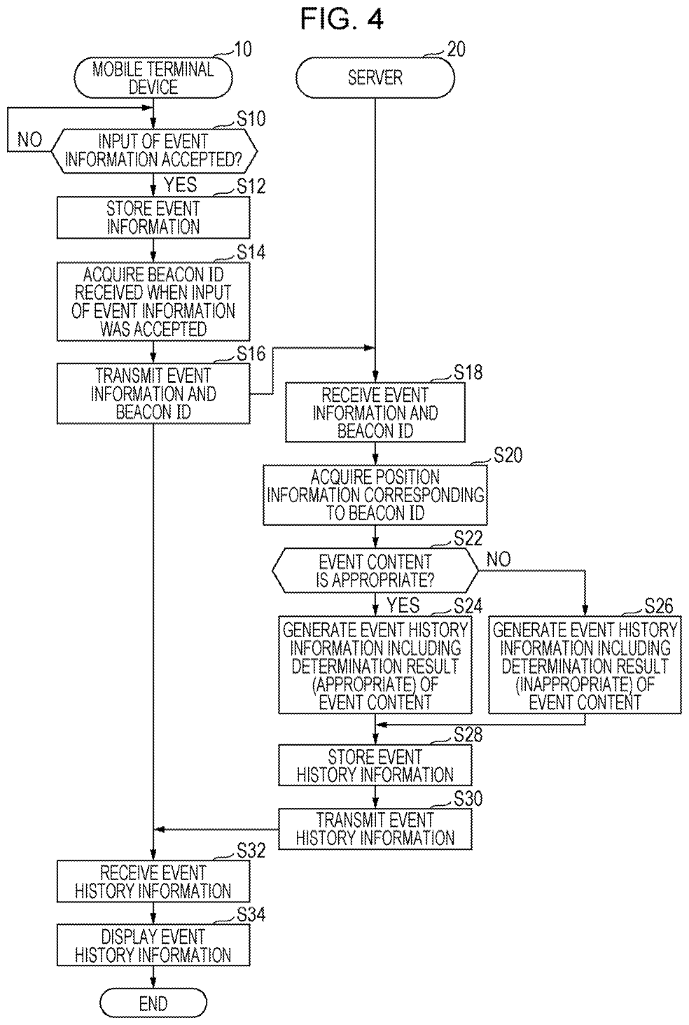

FIG. 4 is a diagram for explaining operations of the information processing system 1000A according to Embodiment 1. Herein, the mobile terminal device 10 continually receives the beacon signal 33 transmitted from each transmitter 30. Each step of the mobile terminal device 10 below is achieved primarily by the processor 152 executing a program stored in the memory 154. Each step of the server 20 below is achieved primarily by the processor 202 executing a program stored in the memory 204.

Referring to FIG. 4, the mobile terminal device 10 determines whether or not the input of event information related to a care recipient has been accepted from a caregiver through the input device 156 (step S10). Event information is information that includes at least the content of an event occurring for the care recipient. The event content is eating (such as breakfast, lunch, or dinner), urination, defecation, getting out of bed, getting into bed, taking a bath, rehabilitation, and the like, for example. For example, the mobile terminal device 10 may display a user interface screen having software buttons available for inputting event information on the display 158, and accept the input of event information through the touch panel. Additionally, the mobile terminal device 10 may also accept the input of event information by speech input through the microphone 170.

In the case in which the input of event information is not accepted (NO in step S10), the mobile terminal device 10 repeats the process of step S10. In the case in which the input of event information is accepted (YES in step S10), the mobile terminal device 10 stores, in the memory 154, event information including the time of inputting the event information. For example, data in which an event occurrence time of “7:00” corresponding to the time of inputting and event content of “breakfast” are associated is stored in the memory 154.

The mobile terminal device 10 acquires the beacon ID included in the beacon signal 33 received when the input of event information is accepted (step S14). Specifically, the mobile terminal device 10 specifies the beacon ID included in the beacon signal 33 received within a predetermined amount of time (for example, 1 second) from the point in time at which the input of event information is accepted. The mobile terminal device 10 transmits the input event information and the specified beacon ID to the server 20 through the wireless communication unit 160 (step S16). The event information transmitted at this point includes, for example, the content of the event that has occurred (such as “breakfast”, for example), the time at which the input of the event information was accepted (hereinafter also designated the “input time”), and comment content.

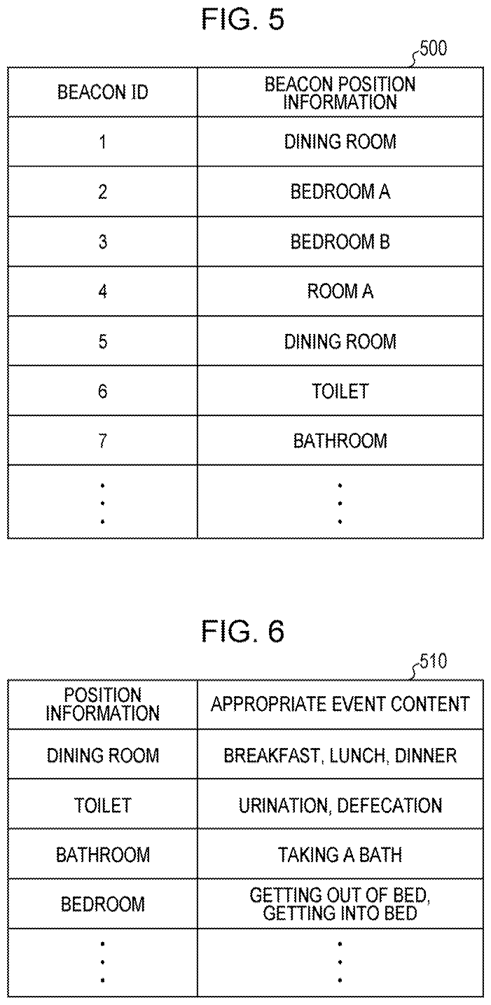

The server 20 receives the event information and the beacon ID through the communication interface 206 (step S18). The server 20 references the information table illustrated in FIG. 5, and acquires beacon position information corresponding to the received beacon ID (step S20). Specifically, the server 20 computes the disposed location of the transmitter 30 that is the source of the beacon signal 33 received by the mobile terminal device 10 at the point in time when the event information was input. In other words, the server 20 computes position information of the mobile terminal device 10 at the point in time when the event information was input.

FIG. 5 is a diagram illustrating device information of a transmitter according to Embodiment 1. The device information 500 includes the identification information (beacon IDs) of the transmitters 30 and beacon position information (location information). Specifically, the device information 500 is information indicating the relationship between the identification information (ID) of each transmitter 30 and the disposed location of each transmitter 30. In the example of FIG. 5, the location where each transmitter 30 is disposed is illustrated as the beacon position information. For example, the transmitter 30 corresponding to the beacon ID “2” is disposed in a bedroom A. For this reason, in the case of receiving the beacon ID “2”, the server 20 is able to determine that the position of the mobile terminal device 10 is in the bedroom A.

Referring again to FIG. 4, the server 20 references the determination table illustrated in FIG. 6 to determine whether or not the event content included in the received event information is appropriate as the content of an event occurring at the location indicated by the computed position information of the mobile terminal device 10 (step S22).

FIG. 6 is a diagram illustrating the determination table according to Embodiment 1. Referring to FIG. 6, the determination table 410 is information indicating the relationship between position information and event content that should occur (is appropriate) at the location indicated by the position information. In the case in which the location indicated by the position information of the mobile terminal device 10 is “dining room”, the appropriate event content is indicated to be one of “breakfast”, “lunch”, and “dinner”. Similarly, in the case in which the position information of the mobile terminal device 10 is “toilet”, the appropriate event content is indicated to be “urination” or “defecation”, while in the case in which the position information is “bathroom”, the appropriate event content is indicated to be “taking a bath”, and in the case in which the position information is “bedroom”, the appropriate event content is indicated to be “getting into bed” or “getting out of bed”.

For example, in the case in which the position information computed in step S20 is “dining room” and the event content according to the event information received in step S18 is “breakfast”, the server 20 determines that the event content is appropriate. Also, in the case in which the computed position information is “bathroom” and the event content according to the received event information is “breakfast”, the server 20 determines that the event content is inappropriate.

Referring again to FIG. 4, in the case in which the event content is appropriate (YES in step S22), the server 20 generates event history information that includes the determination result (Appropriate) of the event content (step S24), and stores the generated event history information in the memory 204 (step S28). On the other hand, in the case in which the event content is inappropriate (NO in step S22), the server 20 generates event history information that includes the determination result (Inappropriate) of the event content (step S26), and stores the generated event history information in the memory 204 (step S28).

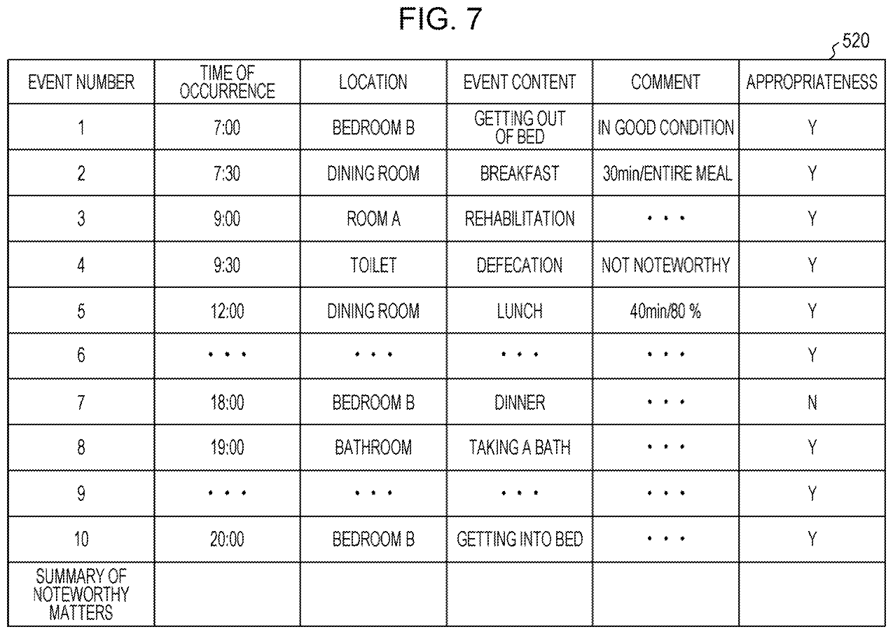

FIG. 7 is a diagram illustrating event history information according to Embodiment 1. Referring to FIG. 7, the event history information includes an event number, the time when the event occurred, the place where the event occurred, the content of the event that occurring, a comment, and an appropriateness determination result. The time of occurrence, or, corresponds to the input time of the event information received from the mobile terminal device 10. The place of occurrence corresponds to the position information of the mobile terminal device 10 computed in step S20. The comment corresponds to a comment received from the mobile terminal device 10. The appropriateness determination result corresponds to the determination result in step S22.

For example, in the example of FIG. 7, referring to the event information corresponding to the event number “1”, it is indicated that the event content “getting out of bed” occurred at the time “7:00” at the location “bedroom B”, and that the event content is appropriate (corresponding to the ◯ symbol in the diagram). In the comment field, it is indicated that the state of the care recipient is “in good condition”. Referring to the event information corresponding to the event number “7”, it is indicated that the event content “dinner” occurred at the time “18:00” at the location “bedroom B”, and that the event content is inappropriate (corresponding to the X symbol in the diagram).

Every time event information is received, the server 20 updates the event history information 520 by adding the received event information. The event history information 520 illustrated in FIG. 7 is in a state in which event information corresponding to each of the event numbers from “1” to “10” has been added.

Referring again to FIG. 4, the server 20 transmits the event history information 520 to the mobile terminal device 10 through the communication interface 206 (step S30).

The mobile terminal device 10 receives the event history information 520 through the wireless communication unit 160 (step S32), and displays the received event history information 520 on the display 158 (step S34).

In the above step S30, the server 20 may also be configured to transmit the event history information to a predetermined PC. In this case, the predetermined PC receives the event history information, and stores the event history information in internal memory.

Also, as another method by which the mobile terminal device 10 acquires its own position information, a method is conceivable in which the mobile terminal device 10 transmits the received radio wave intensity and the beacon ID to the server 20, and the server 20 acquires the position information on the basis of the information, and transmits the position information to the mobile terminal device 10 or a PC for recording (data saving). Also, as yet another method, it is conceivable for the mobile terminal device 10 to receive the radio waves of multiple beacon IDs, acquire its own position information from the radio wave intensities by a method such as triangulation, and transmit the acquired position information to the server 20.

### <Modifications>

Embodiment 1 above describes a configuration in which the device information 500 is stored in the memory 204 of the server 20, but the configuration is not limited thereto. For example, the device information 500 may also be configured to be stored in the memory 154 of the mobile terminal device 10. In this case, the processor 152 of the mobile terminal device 10 may also be configured to execute the processes corresponding to steps S20 to S28 in FIG. 4. In other words, the processor 152 may execute the process of acquiring the position information of the mobile terminal device 10, the process of determining the event content, the process of generating the event history information, and the process of storing the event history information.

Embodiment 1 above describes an example in which the subject is the care recipient, but the caregiver may also be the subject. In the case in which the caregiver is the subject, the work content of the caregiver oneself may be input as the event information. In other words, a behavior record of the caregiver oneself for which position information is acquired may also be input as the event information.

### <Advantages>

According to Embodiment 1, the caregiver is able to easily reconfirm the behavior of the care recipient (subject) for the day. Additionally, the caregiver is also able to use the event history information 520 as a care record (behavior record) of the care recipient. For this reason, it becomes possible to understand the behavior of the care recipient appropriately, while also reducing the burden on the caregiver (for example, the burden of leaving a behavior record of the care recipient). Also, since it is determined whether or not the behavior of the care recipient is being performed at an appropriate position, the reliability of the created behavior record is ensured.

### Embodiment 2

In Embodiment 1, a situation is presumed in which the care recipient engages in behavior while being attended by the caregiver. In Embodiment 2, a situation is presumed in which the care recipient engages in behavior away from the caregiver.

### <System Configuration>

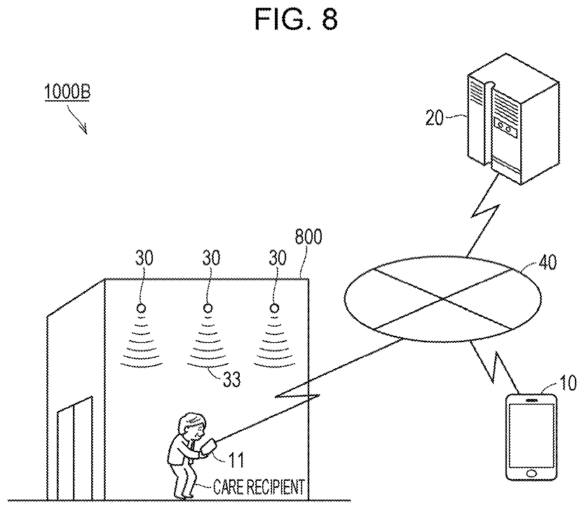

FIG. 8 is a diagram illustrating an overall configuration of an information processing system 1000B according to Embodiment 2. The information processing system 1000B differs from the information processing system 1000A by including a mobile terminal device 11 of the care recipient. Hereinafter, the parts that are different from Embodiment 1 will be described.

The mobile terminal device 11 has a hardware configuration similar to the mobile terminal device 10, and is carried by the care recipient. The mobile terminal device 11 is configured to be able to communicate with the mobile terminal device 10 over the network 40. The mobile terminal device 10 is carried by the caregiver. Note that in Embodiment 2, the user terminal that the caregiver uses does not have to be portable, and may also be a desktop PC or the like, for example. In other words, the mobile terminal device 10 according to Embodiment 2 may be replaced with a non-mobile terminal device.

The mobile terminal device 11 receives the beacon signal 33 transmitted from each transmitter 30, and transmits the beacon ID included in the received beacon signal 33 to the server 20. For this reason, by referencing the device information 500 illustrated in FIG. 5, the server 20 is able to compute the current position information of the mobile terminal device 11. By querying the server 20 for the current position information of the mobile terminal device 11, the mobile terminal device 10 is able to acquire the current position information of the mobile terminal device 11.

### <Example Operations of System>

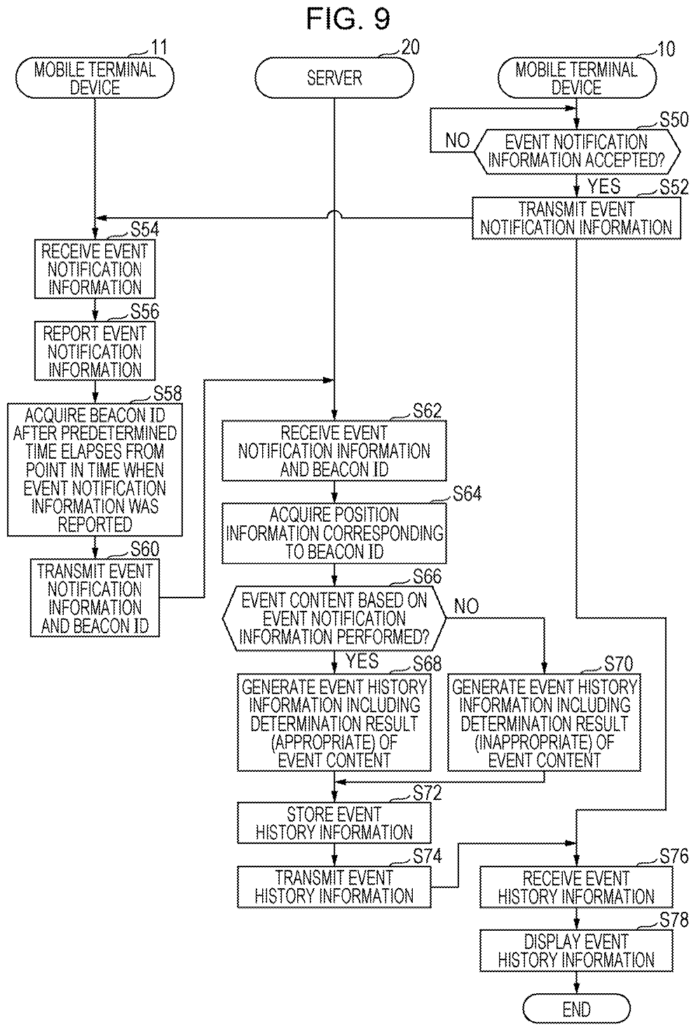

FIG. 9 is a diagram for explaining an example of operations of the information processing system 1000B according to Embodiment 2.

Referring to FIG. 9, the mobile terminal device 10 determines whether or not the input of event notification information for notifying the care recipient has been accepted through the input device 156 (step S50). The event notification information is information for notifying the care recipient of event content that the caregiver wants the care recipient to carry out. The event notification information is information encouraging the care recipient to eat (for example, “Please eat something”), information encouraging the care recipient to take a bath (for example, “Please take a bath”), and the like. The event notification information may also be information (for example, “Please go to the bathroom”) encouraging the care recipient to go to a suitable place (for example, “bathroom”) for carrying out the event content (for example, “taking a bath”).

For example, the mobile terminal device 10 may display a user interface screen having software buttons available for inputting event notification information on the display 158, and accept the input of event information through the touch panel. Additionally, the mobile terminal device 10 may also accept the input of event notification information by speech input through the microphone 170.

In the case in which the input of event notification information is not accepted (NO in step S50), the mobile terminal device 10 repeats the process of step S50. In the case in which the input of event notification information is accepted (YES in step S50), the mobile terminal device 10 transmits the event notification information to the mobile terminal device 11 (step S52).

The mobile terminal device 11 receives the event notification information (step S54) and reports the received event notification information to the care recipient (step S56). For example, the mobile terminal device 11 may display the event notification information on the display 158, or output the event notification information as sound through the speaker 168.

The mobile terminal device 11 acquires the beacon ID included in the beacon signal 33 received after a reference time T1 elapses from the point in time when the event notification information was reported (step S58). The reference time T1 accounts for the time it takes for the care recipient to reach the location where the event should be carried out from the point in time when the care recipient receives the report of the event notification information. The reference time T1 may be a preset time or may be a time decided according to the event notification content. In the case in which the reference time T1 is decided according to the event notification content, the mobile terminal device 10 transmits the event notification information together with information indicating the reference time T1 to the mobile terminal device 11, for example.

Next, the mobile terminal device 11 transmits the received event notification information and the acquired beacon ID to the server 20 (step S60). The server 20 receives the event notification information and the beacon ID (step S62). The server 20 references the information table (device information 500) illustrated in FIG. 5, and acquires beacon position information corresponding to the received beacon ID (step S64). In other words, the server 20 computes position information of the mobile terminal device 11 after the reference time T1 elapses from the point in time when the event notification information was reported.

On the basis of the determination table 410 of FIG. 6 and the computed position information of the mobile terminal device 11, the server 20 determines whether or not the care recipient has carried out the event content based on the event notification information (step S66).

Specifically, the server 20 extracts event content based on the event notification information. For example, in the case in which the event notification information is the information “Please take a bath” encouraging the care recipient to take a bath, the server 20 extracts “taking a bath” as the event content from the event notification information. Also, in the case in which the event notification information is the information “Please go to the bathroom” encouraging the care recipient to take a bath, the server 20 extracts the event content “taking a bath” that is appropriate at the location “bathroom”. The extraction process is executed by referencing a table for extraction in which locations and event content are associated, for example.

After the extraction process, on the basis of the position information of the mobile terminal device 11 computed in step S64, after the reference time T1 elapses from the point in time when the care recipient receives the report of the event notification information (for example, information encouraging the care recipient to take a bath), the server 20 determines whether or not the care recipient is present at the location (for example, “bathroom”) where the event content (for example, “taking a bath”) based on the event notification information should be carried out.

In the case in which the care recipient is present at the location where the event content should be carried out (for example, in the case of being present in the “bathroom” after the reference time T1 elapses), the server 20 determines (considers) that the care recipient has carried out the event content (for example, “taking a bath”) based on the event notification information. In the case in which the care recipient is not present at the location where the event content should be carried out (for example, in the case of being present in the “dining room” after the reference time T1 elapses), the server 20 determines that the care recipient has not carried out the event content (for example, “taking a bath”) based on the event notification information.

In the case of determining that the care recipient has carried out the event content based on the event notification information (YES in step S66), the server 20 generates event history information 520 including the determination result (Appropriate) (step S68), and stores the generated event history information 520 in the memory 204 (step S72). The “location”, “event content”, and “appropriateness” in the event history information 520 illustrated in FIG. 7 correspond to, for example, the position information of the mobile terminal device 11 after the reference time T1 elapses from the point in time when the event notification information was reported, the event content based on the event notification information, and the determination result (Appropriate), respectively.

On the other hand, in the case of determining that the care recipient has not carried out the event content based on the event notification information (NO in step S66), the server 20 generates event history information 520 including the determination result (Inappropriate) (step S70), and stores the generated event history information 520 in the memory 204 (step S72). In this case, the “appropriateness” in the event history information 520 corresponds to the determination result (Inappropriate).

The server 20 transmits the event history information 520 to the mobile terminal device 10 (step S74). The mobile terminal device 10 receives the event history information 520 (step S76), and displays the event history information 520 on the display 158 (step S78).

### <Modifications>

(1) Embodiment 2 above describes a configuration in which, after a reference time T1 elapses from the point in time of the reporting of event notification information, if the care recipient is present at the location where the event content should be performed based on the event notification information, the care recipient is considered to have performed the event content. However, the configuration is not limited thereto. For example, a configuration is also possible in which, after the reference time T1 elapses, if the care recipient is present at the location where the event content should be performed and an event content end notification is received from the mobile terminal device 11 of the care recipient, the server 20 determines that the care recipient has performed the event content. For example, in the case of accepting the input of information indicating that the event content has ended, the mobile terminal device 11 transmits an event content end notification to the server 20.

Alternatively, a configuration is also possible in which, after the reference time T1 elapses from the point in time of the reporting of the event notification information, if the care recipient is present at the location where the event content should be performed, and after a reference time T2 (where T2>T1) elapses from that point in time, if the care recipient is not present at the location where the event content should be performed, the server 20 determines that the care recipient has performed the event content. In other words, in the case in which the care recipient is present in the location where the event content should be performed during the period from the elapse of the reference time T1 to the elapse of the reference time T2, the server 20 considers that the care recipient has performed the event content during the period and makes the above determination.

(2) The server 20 may also analyze (such as by machine learning, for example) a movement path and a movement time obtained from the position information of the mobile terminal device 11, and provided the results of the analysis to the mobile terminal device 10. By providing the results as feedback to the mobile terminal device 10 of the caregiver, it is possible to change the event notification content (such as the event content and schedule, for example).

(3) In the case of accepting the input of information indicating an abnormality of the care recipient, the mobile terminal device 11 of the care recipient may be configured to output information indicating the abnormality. For example, in the case of accepting the input of information indicating an emergency state of the care recipient through the input device 156, the mobile terminal device 11 may display the information on the display 158, output the information as sound through the speaker 168, and transmit the information to the server 20 and the mobile terminal device 10.

(4) In Embodiment 2 described above, the device information 500 may also be configured to be stored in the memory 154 of the mobile terminal device 11. In this case, the processor 152 of the mobile terminal device 11 may also be configured to execute the processes corresponding to steps S64 to S72 in FIG. 9. In other words, the processor 152 may execute the process of acquiring the position information of the mobile terminal device 11, the process of determining whether the event content is performed, the process of generating the event history information, and the process of storing the event history information.

### <Advantages>

According to Embodiment 2, by giving instructions to the care recipient remotely, the caregiver is able to easily reconfirm the behavior of the care recipient for the day. Additionally, the caregiver is also able to use the event history information as a care record of the care recipient.

Also, in Embodiment 2, by having the caregiver give instructions about the event content rather than attend the care recipient, the care recipient is encouraged to act autonomously. For this reason, for example, in the case in which the event content is “rehabilitation”, it is possible to encourage the care recipient to actively engage in rehabilitation.

### Embodiment 3

Embodiment 1 describes a configuration in which multiple transmitters 30 are distributed inside the region 800. Embodiment 3 describes a configuration in which multiple receivers 50 are distributed over the region 800.

### <System Configuration>

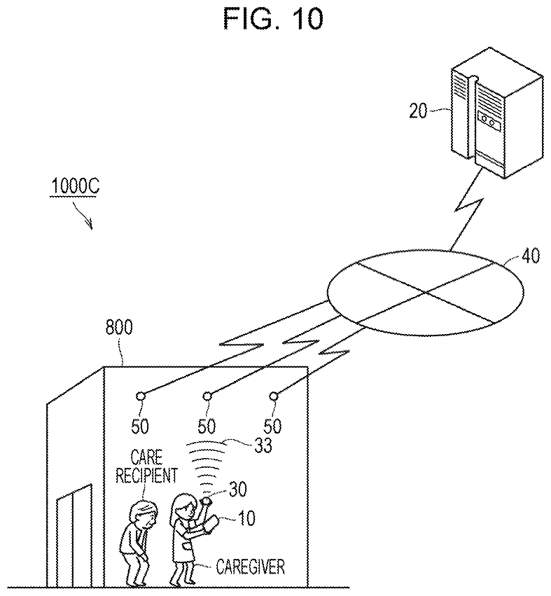

FIG. 10 is a diagram illustrating an overall configuration of an information processing system 1000C according to Embodiment 3. Referring to FIG. 10, the information processing system 1000C includes the mobile terminal device 10 of the caregiver, the server 20, the transmitter 30, the network 40, and multiple receivers 50. In Embodiment 3, a situation is presumed in which the care recipient engages in behavior while being attended by the caregiver. Also, it is presumed that the mobile terminal device 10 and the transmitter 30 are carried by the caregiver. Note that a configuration is also possible in which the caregiver carries a mobile terminal device integrating the mobile terminal device 10 and the transmitter 30.

The multiple receivers 50 are distributed over the region 800. For example, the receivers 50 are compact reception modules (for example, receiving beacon modules) with a built-in reception circuit for receiving the beacon signal 33 transmitted from the transmitter 30, and are equipped with a battery as a driving source. The receivers 50 may also include a solar cell element as an independent power source. For example, the solar cell element is a dye-sensitized solar cell element.

The locations where the receivers 50 are disposed are similar to the locations where the transmitters 30 are disposed in Embodiment 1, including various places such as the dining room, the bedroom, the rehabilitation room, the toilet, the bathroom, and the like, for example. In the case in which one of the receivers 50 receives the beacon signal 33 through a built-in communication interface, the receiver 50 transmits identification information (a receiver ID) of the receiver 50 to the server 20.

The server 20 stores device information about the receivers 50 in the memory 204. For example, device information about each receiver 50 includes identification information (the receiver ID) of the receiver 50 and position information (location information) about the receiver 50. Specifically, the device information about the receivers 50 is information indicating the relationship between the identification information of each receiver 50 and the location where each receiver 50 is disposed, and corresponds to replacing the “beacon ID” and the “beacon position information” in the information table illustrated in FIG. 5 with the receiver ID and the position information of each receiver 50, respectively. In this case, the receiver 50 corresponding to the receiver ID “2” is disposed in the bedroom A.

### <Example Operations of System>

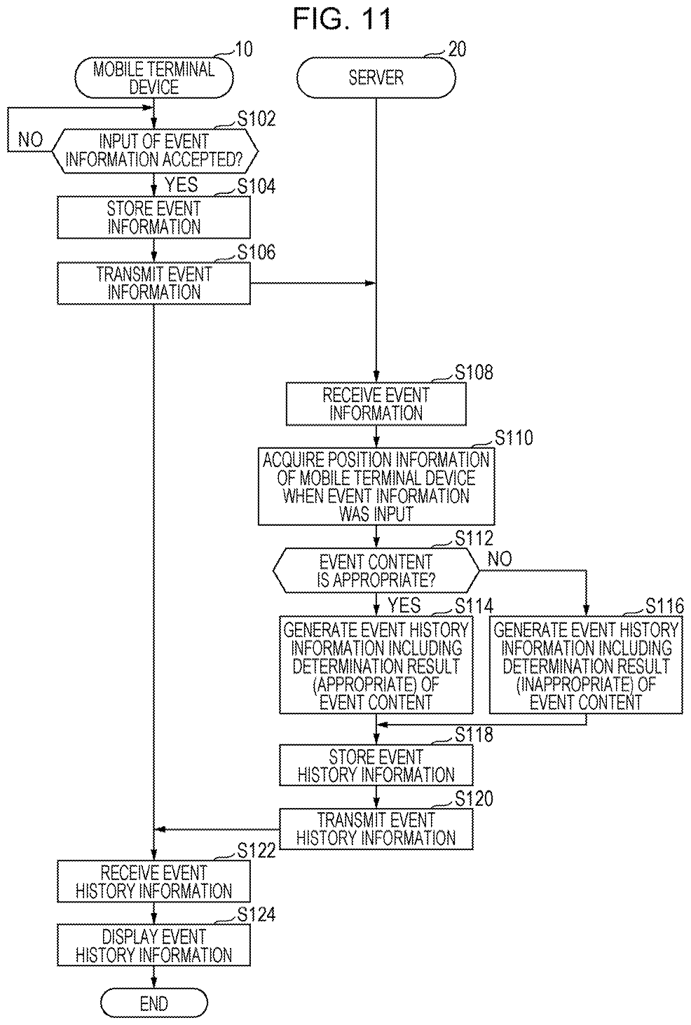

FIG. 11 is a diagram for explaining an example of operations of the information processing system 1000C according to Embodiment 3. Herein, it is presumed that the transmitter 30 carried by the caregiver continually transmits the beacon signal 33, and when each receiver 50 receives the beacon signal 33 from the transmitter 30, each receiver 50 transmits its receiver ID to the server 20.

Referring to FIG. 11, since the processes in steps 5102 and 5104 are similar to the processes in steps S10 and S12 in FIG. 4, a detailed description will not be repeated. The mobile terminal device 10 transmits the input event information to the server 20 (step S106).

The server 20 receives the event information (step S108). The server 20 acquires the position information of the mobile terminal device 10 at the point in time when the input of the event information was accepted (step S110). Specifically, the server 20 references the memory 204 and computes the disposed location of the receiver 50 corresponding to the receiver ID that the server 20 received within a predetermined time (for example, 1 second) from the point in time when the event information was input as the position information.

The processes of steps S112 to S120 executed by the server 20 are similar to the processes of S22 to S30 in FIG. 4, respectively. The processes of steps S122 and S124 executed by the mobile terminal device 10 are similar to the processes of S32 and S34 in FIG. 4, respectively. For this reason, a detailed description will not be repeated for these processes.

### <Advantages>

According to Embodiment 3, advantages similar to Embodiment 1 are obtained.

### Embodiment 4

In Embodiment 3, a situation is presumed in which multiple receivers 50 are disposed in various places inside the region 800, and the care recipient engages in behavior while being attended by the caregiver. In Embodiment 4, a situation is presumed in which multiple receivers 50 are disposed in various places inside the region 800, and the care recipient engages in behavior away from the caregiver.

### <System Configuration>

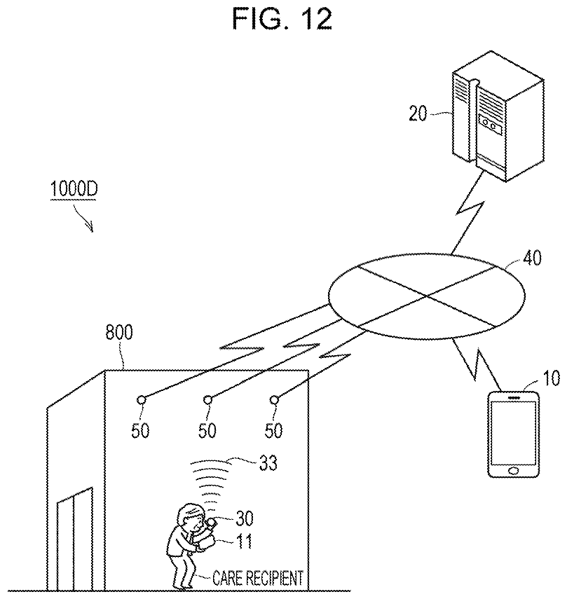

FIG. 12 is a diagram illustrating an overall configuration of an information processing system 1000D according to Embodiment 4. The information processing system 1000D differs from the information processing system 1000C according to Embodiment 3 by including the mobile terminal device 11 of the care recipient. Also, the information processing system 1000D differs from the information processing system 1000B according to Embodiment 2 in that multiple receivers 50 are disposed inside the region 800, and the transmitter 30 is carried by the care recipient. Hereinafter, the parts that are different from Embodiments 2 and 3 will be described.

The mobile terminal device 11 and the transmitter 30 are carried by the care recipient. Note that a configuration is also possible in which the care recipient carries a mobile terminal device integrating the mobile terminal device 11 and the transmitter 30.

### <Example Operations of System>

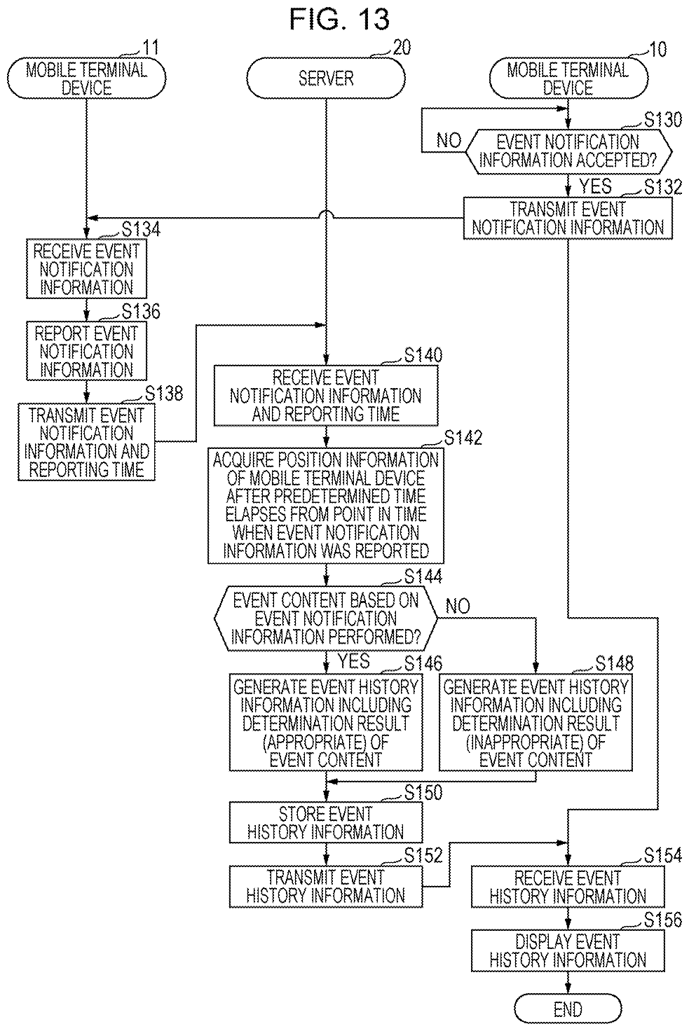

FIG. 13 is a diagram for explaining an example of operations of the information processing system 1000D according to Embodiment 4. Herein, it is presumed that the transmitter 30 carried by the caregiver continually transmits the beacon signal 33, and when each receiver 50 receives the beacon signal 33 from the transmitter 30, each receiver 50 transmits its receiver ID to the server 20.

Referring to FIG. 13, since the processes in steps S130 and S132 executed by the mobile terminal device 10 are similar to the processes in steps S50 and S52 in FIG. 9, respectively, a detailed description will not be repeated.

Since the processes in steps S134 and S136 executed by the mobile terminal device 11 are similar to the processes in steps S54 and S56 in FIG. 9, respectively, a detailed description will not be repeated. The mobile terminal device 11 transmits event notification information and the time of reporting the event notification information (reporting time) to the server 20 (step S138).

The server 20 receives the event notification information and the reporting time (step S140). The server 20 acquires the position information of the mobile terminal device 11 after the elapse of the reference time T1 from the reporting time of the event notification information (step S142). Specifically, the server 20 computes the disposed location of the receiver 50 corresponding to the receiver ID received most recently after the elapse of the reference time T1 from the reporting time of the event notification information as the position information.

The processes of steps S144 to S152 executed by the server 20 are similar to the processes of S66 to S74 in FIG. 9, respectively. The processes of steps S154 and S156 executed by the mobile terminal device 10 are similar to the processes of S76 and S78 in FIG. 9, respectively. For this reason, a detailed description will not be repeated for these processes.

### <Advantages>

According to Embodiment 4, advantages similar to Embodiment 2 are obtained.

### Embodiment 5

Embodiment 5 describes a configuration that determines whether or not event content has ended by utilizing a device associated with the event content.

### <System Configuration>

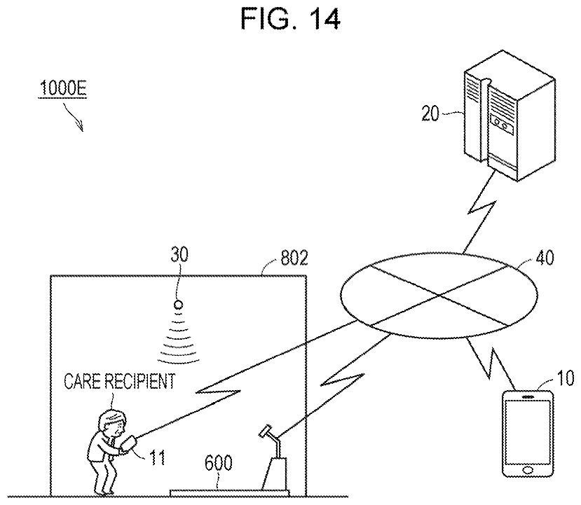

FIG. 14 is a diagram illustrating an overall configuration of an information processing system 1000E according to Embodiment 5. As illustrated in FIG. 14, the information processing system 1000E presumes a situation in which the care recipient carrying the mobile terminal device 11 performs the event content “rehabilitation” in a rehabilitation room 802 inside the region 800.

In the rehabilitation room 802, a transmitter 30 is disposed and a rehabilitation device 600 is provided. The rehabilitation device 600 is a treadmill, an aerobike (registered trademark), a step machine, or the like, for example.

The rehabilitation device 600 includes a processor for controlling the device as a whole, an input device that accepts input from the care recipient, a communication interface for connecting to the network 40, memory, a sensor device for detecting the operating status, and the like.

The rehabilitation device 600 accepts the input of the user information of the care recipient. The rehabilitation device 600 transmits the user information and information indicating that rehabilitation has ended to the server 20 over the network 40. Specifically, in the case of determining that the event content “rehabilitation” by the care recipient has ended, the rehabilitation device 600 transmits rehabilitation end information to the server 20.

For example, suppose a case in which the rehabilitation device 600 is a treadmill or an aerobike. In this case, if the distance measured by a distance-measuring meter reaches a predetermined distance, the rehabilitation device 600 determines that rehabilitation has ended, and transmits the rehabilitation end information and the user information to the server 20. Alternatively, after the operation of the rehabilitation device 600 itself is detected, if the distance measured by the distance-measuring meter does not change for a fixed amount of time (for example, 30 minutes), the rehabilitation device 600 may also determine that rehabilitation has ended, and transmit the rehabilitation end information and the user information to the server 20.

The server 20 or the mobile terminal device 10, by receiving the user information and the rehabilitation end information, is able to understand that the event content “rehabilitation” by the care recipient has ended.

The above describes the rehabilitation device 600 as an example because the event content is “rehabilitation”, but the configuration is not limited thereto. For example, in the case in which the event content is “urination”, the device may also be a toilet device or the like. For this reason, it is sufficient for the configuration to be one in which the server 20 or the mobile terminal device 10 determines whether or not event content has ended on the basis of event end information transmitted from a predetermined device associated with the event content to be performed by the care recipient.

### <Advantages>

According to Embodiment 5, it is possible to grasp the end of event content accurately.

### Embodiment 6

Embodiment 1 describes a configuration in which, when the care recipient engages in behavior while being attended by the caregiver, only the caregiver carries a mobile terminal device. Embodiment 6 describes a configuration in which the caregiver and the care recipient carry mobile terminal devices.

### <System Configuration>

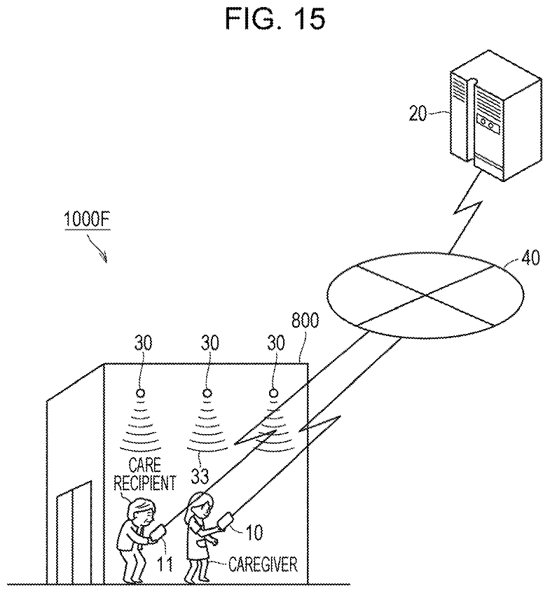

FIG. 15 is a diagram illustrating an overall configuration of an information processing system 1000F according to Embodiment 6. The information processing system 1000F differs from the information processing system 1000A in that the care recipient carries the mobile terminal device 11. Hereinafter, the parts that are different from Embodiment 1 will be described.

The mobile terminal devices 10 and 11 receive the beacon signal 33 transmitted from each transmitter 30, and transmit the beacon ID included in the received beacon signal 33 to the server 20. For this reason, by referencing the device information 500 illustrated in FIG. 5, the server 20 is able to compute the current position information of the mobile terminal devices 10 and 11.

### <Example Operations of System>

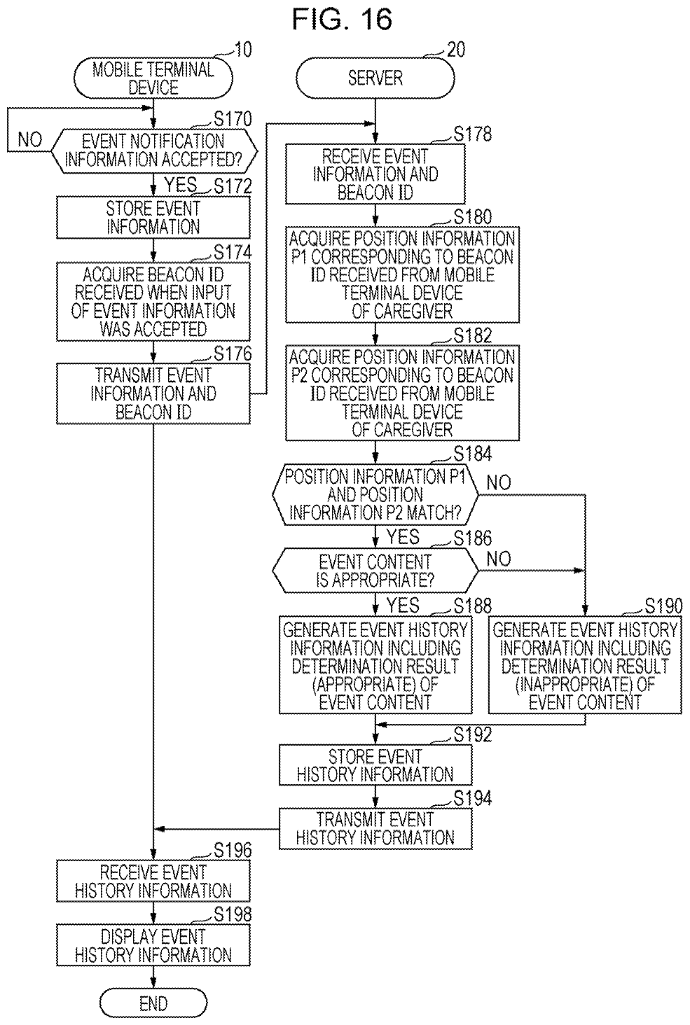

FIG. 16 is a diagram illustrating one example of operations of the information processing system 1000F according to Embodiment 6. Herein, assume that the mobile terminal device 11 receives the beacon signal 33 transmitted from each transmitter 30, and continually transmits the beacon ID included in the received beacon signal 33 to the server 20.

Referring to FIG. 16, since the processes in steps S170 to S176 executed by the mobile terminal device 10 are similar to the processes in steps S10 to S16 in FIG. 4, respectively, a detailed description will not be repeated.

The server 20 receives event information and the beacon ID from the mobile terminal device 10 (step S178). The server 20 references the information table (device information 500) illustrated in FIG. 5, and acquires beacon position information corresponding to the beacon ID received from the mobile terminal device 10 (step S180). In other words, the server 20 computes position information P1 of the mobile terminal device 10 at the point in time when the event information was input.

The server 20 acquires beacon position information corresponding to the beacon ID received from the mobile terminal device 11 at the event input time included in the event information received from the mobile terminal device 10 (step S182). In other words, the server 20 computes position information P2 of the mobile terminal device 11 at the point in time when the event information was input.

The server 20 determines whether or not the position information P1 and the position information P2 match (step S184). In the case in which the pieces of information do not match (NO in step S184), the server 20 generates event history information that includes the determination result (Inappropriate) of the event content (step S190). In other words, in the case in which the caregiver and the care recipient are not engaging in behavior together, the server 20 generates event history information including a determination result indicating the event content is inappropriate. In the case in which the pieces of information match (YES in step S184), the server 20 references the determination table 410 to determine whether or not the event content included in the received event information is appropriate as event content at the location indicated by the position information P1 and the position information P2 (step S186).

In the case in which the event content is appropriate (YES in step S186), the server 20 generates event history information that includes the determination result (Appropriate) of the event content (step S188), and stores the generated event history information in the memory 204 (step S192). The generated event history information corresponds to the event history information 520 illustrated in FIG. 7 with the addition of the position information of the mobile terminal device 11. On the other hand, in the case in which the event content is inappropriate (NO in step S186), the server 20 generates event history information that includes the determination result (Inappropriate) of the event content (step S190), and stores the generated event history information in the memory 204 (step S192). The server 20 transmits the event history information to the mobile terminal device 10 (step S194).

Since the processes in steps 5196 and 5198 executed by the mobile terminal device 10 are similar to the processes in steps S32 and S34 in FIG. 4, respectively, a detailed description will not be repeated.

### <Advantages>

According to Embodiment 6, in the case in which the caregiver and the care recipient are not engaging in behavior together, the event content is determined to be inappropriate. For this reason, it is possible to generate more accurate event history information.

### Other Embodiments

Note that it is also possible to provide a program causing a computer to function and execute control as described in the foregoing embodiments. It is also possible to record such a program onto a non-transitory computer-readable recording medium such as a flexible disk, a Compact Disc-Read-Only Memory (CD-ROM), ROM, RAM, and a memory card that attaches to a computer, and provide the medium as a program product. Alternatively, it is also possible to provide the program recorded onto a recording medium such as a hard disk built into a computer. In addition, it is also possible to provide the program by downloading over a network.

The program may also be one that, among program modules provided as part of the operating system (OS) of a computer, calls required modules in a predetermined order at predetermined timings to execute processes. In this case, the above modules are not included in the program itself, and the processes are executed in cooperation with the OS. Such a program that does not include such modules may also be included as the program according to the present embodiment.

In addition, the program according to the present embodiment may also be provided incorporated into a part of another program. Likewise, in this case, modules included in the other program are not included in the program itself, and processes are executed in cooperation with the other program. Such a program incorporated into another program may also be included as the program according to the present embodiment.

Also, in Embodiments 1 to 6 described above, an example in which a nursing home is presumed as the region 800 and the subject is a care recipient or a caregiver is described, but the region 800 is not limited to a nursing home, and likewise the subject is not limited to a care recipient or a caregiver. The region 800 may also be a hospital, a commercial facility, an airport, a train station, an office building, or the like. The subject may also be a human being, an animal, a robot, or the like for whom both position information and a behavior record inside the range of the region 800 are recorded.

### Conclusion

A summary of the content described through the foregoing embodiments is largely as follows.

(1) The information processing system 1000A using the mobile terminal device 10 includes multiple transmission devices (transmitters 30) that are distributed over a predetermined region (region 800) and that transmit mutually different identification information (a beacon ID). The processor 152 of the mobile terminal device 10 includes a reception unit that receives the beacon ID through the communication interface 166. The server 20 includes an information storage unit (memory 204) that stores device information 500 including, for each of the multiple transmitters 30, the beacon ID and the beacon position information of the transmitter 30.

The processor 152 of the mobile terminal device 10 includes an input unit that accepts the input of event information related to the care recipient through the input device 156. The processor 202 of the server 20 includes an acquisition circuitry that, on the basis of the beacon ID received by the reception unit and the device information 500, acquires the position information of the mobile terminal device 10 at the point in time when the input of the event information was accepted by the input unit. The processor 202 of the server 20 includes an output unit that outputs (transmits), through the communication interface 206, event history information 520 about the care recipient that includes the event information related to the care recipient and the position information of the mobile terminal device 10 at the point in time.

(2) In the information processing system 1000A according to (1) above, the processor 202 of the server 20 includes a determination unit that determines whether or not the event content included in the event information related to the care recipient is appropriate as event content at the location indicated by the acquired position information of the mobile terminal device 10.

(3) The information processing system 1000B using the mobile terminal device 11 of the care recipient and the mobile terminal device 10 of the caregiver includes multiple transmission devices (transmitters 30) that are distributed over a predetermined region (region 800) and that transmit mutually different identification information (a beacon ID). The processor 152 of the mobile terminal device 11 includes a reception unit that receives the beacon ID through a first communication interface (communication interface 166). The server 20 includes an information storage unit (memory 204) that stores device information 500 including, for each of the multiple transmitters 30, the beacon ID and the beacon position information of the transmitter 30.

The processor 152 of the mobile terminal device 11 includes a notification information reception unit that receives event notification information from the mobile terminal device 10 through a second communication interface (the wireless communication unit 160 and the communication antenna 162), and a reporting unit that reports the event notification information. The processor 202 of the server 20 includes an acquisition circuitry that, on the basis of the beacon ID received by the reception unit and the device information 500, acquires the position information of the mobile terminal device 11 after a predetermined amount of time (the reference time T1) elapses from the point in time when the event notification information was reported by the reporting unit. The processor 202 of the server 20 includes an output unit that outputs (transmits), through the communication interface 206, event history information about the care recipient that includes event content based on the event notification information and the position information of the mobile terminal device 11 after the reference time T1 elapses.

(4) In the information processing system 1000B according to (3) above, the processor 202 of the server 20 additionally includes a determination unit that determines, on the basis of the position information of the mobile terminal device 11 acquired by the acquisition circuitry, whether or not the care recipient has performed the event content based on the event notification information.

(5) The information processing system 1000C using a mobile terminal device that transmits identification information (a beacon ID) with an internally provided transmission module includes multiple reception devices (receivers 50) distributed over a predetermined region (region 800). Each of the multiple receivers 50 transmits the identification information of the receiver 50 when the beacon ID is received. The server 20 includes an information storage unit (memory 204) that stores, for each of the multiple receivers 50, reception device information including a receiver ID of the receiver 50 and position information about the receiver 50.

The processor 152 of the mobile terminal device includes an input unit that accepts the input of event information related to the care recipient and an event information transmission unit that transmits event information accepted by the input unit to the server 20. The processor 202 of the server 20 includes an acquisition circuitry that, on the basis of the receiver ID transmitted to the server 20 and the reception device information, acquires the position information of the mobile terminal device at the point in time when the input of the event information was accepted by the input unit. The processor 202 of the server 20 includes an output unit that outputs (transmits) event history information about the care recipient that includes the event information related to the care recipient and the position information of the mobile terminal device at the point in time.

(6) The information processing system 1000D using the mobile terminal device of the care recipient and the mobile terminal device 10 of the caregiver that transmit identification information with an internally provided transmission module includes multiple reception devices (receivers 50) distributed over a predetermined region (region 800). Each of the multiple receivers 50 transmits the identification information of the receiver 50 when the beacon ID is received. The server 20 includes an information storage unit (memory 204) that stores, for each of the multiple receivers 50, reception device information including a receiver ID of the receiver 50 and position information about the receiver 50.

The processor 152 of the mobile terminal device includes a notification information reception unit that receives event notification information from the mobile terminal device 10 through a communication interface (the wireless communication unit 160 and the communication antenna 162), and a reporting unit that reports the event notification information.

The processor 202 of the server 20 includes an acquisition circuitry that, on the basis of the receiver ID transmitted to the server 20 and the reception device information, acquires the position information of the mobile terminal device 11 after a predetermined amount of time (the reference time T1) elapses from the point in time when the event notification information was reported by the reporting unit. The processor 202 of the server 20 includes an output unit that outputs (transmits), through the communication interface 206, event history information about the care recipient that includes event content based on the event notification information and the position information of the mobile terminal device 11 after the reference time T1 elapses.

(7) In (3) or (6) above, on the basis of event end information (rehabilitation end information) transmitted from a predetermined device (rehabilitation device 600) associated with event content to be performed by the care recipient, the processor 202 of the server 20 determines whether or not the event content has ended.

(8) The information processing system 1000F using multiple mobile terminal devices includes multiple transmission devices (transmitters 30) that are distributed over a predetermined region (region 800) and that transmit mutually different identification information (a beacon ID). Each processor 152 of the mobile terminal devices 10 and 11 includes a reception unit that receives the beacon ID through each communication interface 166. The server 20 includes an information storage unit (memory 204) that stores device information 500 including, for each of the multiple transmitters 30, the beacon ID and the beacon position information of the transmitter 30.

The processor 152 of the mobile terminal device 10 includes an input unit that accepts the input of event information related to the care recipient through the input device 156. The processor 202 of the server 20 includes an acquisition circuitry that, on the basis of the beacon ID received by the mobile terminal device 10 and the device information 500, acquires the position information of the mobile terminal devices 10 and 11 at the point in time when the input of the event information was accepted by the mobile terminal device 10. The processor 202 of the server 20 includes an output unit that outputs (transmits), through the communication interface 206, event history information 520 about the care recipient that includes the event information related to the care recipient and the position information of the mobile terminal devices 10 and 11 at the point in time.

(9) In the above, the input unit accepts the input of information indicating an abnormality of the care recipient. The processor 152 of the mobile terminal device includes an abnormality information output unit that outputs the information indicating an abnormality.

(10) In the above, each of the multiple transmitters 30 includes a solar cell element as a power source.

(11) In the above, the solar cell element is a dye-sensitized solar cell element.

The configuration illustrated by example as the foregoing embodiments is one example of the configuration of the present disclosure. It is possible to combine the configuration with different publicly available technologies, and it is also possible to alter the configuration, such as by omitting a portion thereof, within a scope that does not depart from the gist of the present disclosure.

Additionally, in some cases, each of the foregoing embodiments may be carried out in appropriate combination with processes and configurations described in a modification or another embodiment.

The embodiments disclosed herein are for illustrative purposes in all points, and should be considered to be non-limiting. The scope of the present disclosure is indicated by the claims rather than the foregoing description, and all modifications within the scope of the claims and their equivalents are to be included in the scope of the present disclosure. REFERENCE SIGNS LIST

10, 11 mobile terminal device

20 server

30 transmitter

33 beacon signal

40 network

50 receiver

152, 202 processor

154, 204 memory

156 input device

158 display

160 wireless communication unit

162 communication antenna

164 memory interface

165 storage medium

166, 206 communication interface

168 speaker

170 microphone

410 determination table

500 device information

520 event history information

600 rehabilitation device

800 region

802 rehabilitation room

1000A to 1000F information processing system

1. An information processing system using a mobile terminal device, comprising:
a plurality of transmission devices that are distributed over a predetermined region and that transmit mutually different identification information;
a receiver, provided in the mobile terminal device, that receives the identification information;
an information storage memory that stores device information including, for each of the plurality of transmission devices, the identification information and position information of the transmission device;
an input device, provided in the mobile terminal device, that accepts an input of event information related to a subject;
an acquisition circuitry that, based on the identification information received by the receiver and the position information, acquires the position information of the mobile terminal device at a point in time when the input of the event information was accepted by the input device; and
an output device that outputs event history information about the subject that includes the event information related to the subject and the position information of the mobile terminal device at the point in time.

2. The information processing system according to claim 1, further comprising:
a determination circuitry that determines whether or not event content included in the event information related to the subject is appropriate as event content at a location indicated by the acquired position information of the mobile terminal device.

3. An information processing system using a mobile terminal device of a subject and a terminal device configured to be able to communicate with the mobile terminal device, the information processing system comprising:
a plurality of transmission devices that are distributed over a predetermined region and that transmit mutually different identification information;
a receiver, provided in the mobile terminal device, that receives the identification information;
an information storage memory that stores device information including, for each of the plurality of transmission devices, the identification information and position information of the transmission device;
a notification information receiver, provided in the mobile terminal device, that receives event notification information from the terminal device;
a report device, provided in the mobile terminal device, that reports the event notification information;
an acquisition circuitry that, based on the identification information received by the receiver and the position information, acquires the position information of the mobile terminal device after a predetermined amount of time elapses from a point in time when the event information was reported by the report device; and
an output device that outputs event history information about the subject that includes event content based on the event notification information and the position information of the mobile terminal device after the predetermined amount of time elapses.

4. The information processing system according to claim 3, further comprising:
a determination circuitry that determines, based on the position information of the mobile terminal device acquired by the acquisition circuitry, whether or not the subject has performed the event content based on the event notification information.

5. The information processing system according to claim 3, wherein
the receiver receives the identification information through a first communication interface, and
the notification information receiver receives the event notification information through a second communication interface.

6. An information processing system using a mobile terminal device that transmits identification information, the information processing system comprising:
a plurality of reception devices distributed over a predetermined region, in which, in a case of receiving the identification information, each of the plurality of reception devices transmits identification information of the reception device to theft server;
an information storage memory, provided in the server, that stores reception device information including, for each of the plurality of reception devices, the identification information and position information of the reception device;
an input device, provided in the mobile terminal device, that accepts an input of event information related to a subject;
an event information, provided in the mobile terminal device, that transmits the event information accepted by the input device to the server;
an acquisition circuitry, provided in the server, that, based on the identification information of the reception device transmitted to the server and the reception device information, acquires the position information of the mobile terminal device at a point in time when the input of the event information was accepted by the input device; and
an output device that outputs event history information about the subject that includes the event information related to the subject and the position information of the mobile terminal device at the point in time.

7. (canceled)

8. (canceled)

9. The information processing system according to claim 3, further comprising:
an end determination circuitry that, based on event end information transmitted from a predetermined device associated with event content to be performed by the subject, determines whether or not the event has ended.

10. (canceled)

11. The information processing system according to claim 1, wherein
the input device accepts an input of information indicating an abnormality of the subject, and
the information processing system further comprises an abnormality information output device, provided in the mobile terminal device, that outputs information indicating the abnormality.

12. The information processing system according to claim 1, wherein
each of the plurality of transmission devices includes a solar cell element as a power source.

13. The information processing system according to claim 12, wherein
the solar cell element is a dye-sensitized solar cell element.
